(19) United States
(12) Patent Application Publication
(10) Pub. No.: US 2012/0123903 A1
(43) Pub. Date: May 17, 2012

(54) METHOD OF CONDUCTING TRANSACTIONS OVER THE INTERNET

(75) Inventors: Zhiming Yu, Yuyao City (CN); Yuehai Yu, Yuyao City (CN)

(73) Assignee: AFCC LLC, Wilmington, DE (US)

(21) Appl. No.: 13/293,327

(22) Filed: Nov. 10, 2011

(30) Foreign Application Priority Data
Nov. 11, 2010 (CN) 201010549496.X

(51) Int. Cl. G06Q 30/02

(52) U.S. Cl. 705/26.35

(57) ABSTRACT

A method of conducting transactions over the Internet, comprising the steps: opening an online market; applying membership, wherein a member is classified into classes A, B or C; class A member is a professional institution/person who provides security services for a market transaction order; class B member is a seller/provider who participates in network goods/service transactions; and class C member is a purchaser who participates in the network goods/service transactions; establishing a market website; equipping with a website server; drafting market rules; wherein class A member verifies authenticity of general and performance information, which are inputted into market website server by a market administrative institution, declared by class B member; the members learn about financial conditions from one another via the Internet by using a network terminal unit, and negotiate online transactions and sign a contract; and the seller/provider provides goods/service, whereas the buyer fulfill online payment.

### FIELD OF THE INVENTION

The present invention relates to a method of conducting transactions over the Internet.

### BACKGROUND OF THE INVENTION

Transaction over the Internet has common disadvantages that since network is virtual, both sides of transaction are not acquainted with each other and always don't know whom he/she does business with actually; generally, small and medium enterprises could hardly win confidence for a short term or attain a large amount of business, but be very probably cheated. In addition, in an international online transaction, since legal institution and social culture of various countries (and districts) present diversity, both sides of transaction could hardly clarify rights and obligation in law exactly or anticipate result of the transaction completely. In the case of any dispute, settlement of the dispute will be more difficult.

### BRIEF SUMMARY OF THE INVENTION

In order to eliminate negative effect of virtuality of an online transaction, the present invention provides a method of conducting online transactions for timely acknowledging general information and performance capacity information of participants who conduct the online transactions, conducting transaction according to a whole set of preset rule system, clearly understanding the rights and obligation in law in conducting transactions, easily expecting a transaction result, and settling dispute using the same set of rules when occurring the dispute.

To achieve the present invention, the steps are presented as follows:
1. a method of conducting transactions over the Internet, comprises following components and steps:

1) opening an online market, carrying out membership, members being classified into:

Class B member that is a proprietor participating in the online goods and service transactions for a commercial purpose and has a network terminal apparatus; and

Class C member that is a purchaser participating in the network goods and service transaction for a purpose of compensation and has a network terminal apparatus;

2) establishing a market website, and equipping with a market website server;

3) drafting a whole set of market rules and system which mainly includes members' information recordation, submitting rules, rules of mutually referring information, standard contract and transaction rules, rules of liability for breach of contract, and rules of dispute settlement;

4) wherein the class B member previously confirms acceptance of the online market rules, and according to the rules, faithfully submits individual general information and performance capacity information to a market administrative institution by converting the information as data files to be stored on a magnetic media unit or an optical recording media, or via the Internet by using an individual network terminal unit; the market administrative institution inputs the information into the market website server in a manner that the market administrative institution verifies the information partially or completely depending to the class B member or directly records a part of information; and the market administrative institution marks the verified information and inputs all the unverified and verified information into the market website server;

5) wherein the class C member previously confirms acceptance of the online market rules, and according to the rules, faithfully submits individual general information and performance capacity information to a market administrative institution by converting the information as data files to be stored on the magnetic media unit or the optical recording media, or via the Internet by using the individual network terminal unit; the market administrative institution inputs the information into the market website server; or the market administrative institution verifies the information partially or completely depending on the class C member, or directly records a part of information; and the market administrative institution marks the verified information and inputs all the unverified or verified information into the market website server;

6) wherein the market administrative institution sets a part of basic general information to be browsed online per capita, and hands administrative permission of password of the information that is not desired to be browsed online per capita by the members and performance information to the class B member and the class C member themselves such that the members can manage their information consulted objects in a manner of setting, altering and handing the password;

7) wherein the class B member and the class C member, using their individual network terminal unit, visit the market website server via the network to learn about the basic general information from one another, let the counterpart to know the password at one's own will, and authorize the counterpart to acknowledge partial or complete general information and performance capacity information stored at the market website server via the Internet;

8) wherein between class B members and between the class B member and the class C member, they negotiate transactions and then sign a contract by writing and/or speech over the network on the basis of really having acknowledged the information from one another; and

9) wherein the class B member as a seller provides goods or services; and the class B or C members as a buyer fulfills payment to close the transaction via the network by using the individual network terminal unit.

Furthermore, the member shall bear liability for breach of the contract, if he/she submits fake information, or the submitted goods and services are not in conformity with a contract agreement or a quality standard.

Furthermore, the market administrative institution can initiatively check the information or goods and service submitted by the class B member according to the market rules, for instance, the class B member shall bear for breach of the contract if he/she submits the fake information or the goods and services as submitted are not in conformity with the standard.

Furthermore, in the case of occurrence of any dispute between the members, intermediation or arbitration is conducted so as to settle the dispute, exclusively according to the online market rules.

Furthermore, 10) in the market, there is class A member that is a professional institution or person providing security service for market transaction order and has a network terminal apparatus;

11) the class A member previously confirms acceptance of online market rules, and submits individual general information and performance capacity information to be verified by an online market administrative institution or the other class A members; or a checker directly records the partial or complete information, and submits the information to the market administrative institution by converting the information as data files to be stored on a magnetic media unit or an optical recording media, or sends the information to the market administrative institution over the Internet; and the administrative institution inputs the information into the market website server;

12) the class A member can verify the partial or complete general information and performance capacity information, or directly record the information, and submit verified result or directly recorded information to the market administrative institution, and input the information into the market online server, as requested by the class B and C members or entrusted by the online market administrative institution;

13) the class A member can be entrusted by the market administrative institution to verify whether the class B member has an action of breaking the market rules, and then a decision is made by the market administrative institution; or after verification, when the market administrative institution deems that the class B member' action does not breaking the market rules or does not make a decision in time, an arbitration adjudication can be requested directly;

14) the class A member shall bear for breach of the contract and/or bear joint liability associated with the class B member's breach of contract if the class A member offends his/her duty.

Furthermore, the market administrative institution drafts professional ethics of the junior employees of the market administrative institution and the class A member; and a professional ethic consultative institution is established in the market to deal with lawsuit about the professional ethics.

Furthermore, the market administrative institution copies the members' information in papers, the magnetic media unit or the optical recording media; and the market administrative institution can provide the member' information testified by the market administrative institution according to the member's instructions.

Furthermore, by means of inter-supervision between the class A members, between the class B members, and between the class A member and the class B member, and receiving supervision of the class C member, the members can be rewarded and can be given an ample reward in the food industry relating to security and health of human beings if any active supervision is made.

### DETAILED DESCRIPTION OF THE EMBODIMENTS

A method of online transactions of the present invention will be further described in accordance with the following illustrated embodiments; however, the protection scope sought for protection by the present invention will not be defined within the illustrated embodiments.

### 1. Embodiments with Integrity

Drafting online market rules:

A whole set of market rules, such as members' information recording and submitting rules, rules of mutually referring members' information, members conducting transactions rules, rules of members' liability for breach of a contract, members settling dispute rules, professional ethics for junior employees in the market administrative organization and class A member.

Setting up a professional ethics consultative committee for dealing with lawsuits of the professional ethics;

Setting up a website, equipping with a server, and opening an online market;

Admitting online market members, the members are classified into classes A, B and C:

the class A member that is a professional institution and person providing security service for the market transaction order, mainly including law offices, licensed lawyers, accounting firms and certified accountants and the like;

the class B member that participates in online transactions for commercial purposes, mainly including enterprises and individuals for providing goods and service; and

the class C member that participates online transactions for the purpose of consumption, receives the goods and service, and besides of the ordinary consumers, also including units, such as enterprises or institutions, governments, countries, state organs, armies, and social groups, which participates in the online transactions for the purpose of consumption.

Confirming acceptance of the online market rules before becoming a member; and subsequently,

Submitting and recording class A member's general information and performance capacity information;

As to the class A member as a unit, the basic general information includes name, legal representative or a person in charge, registered residence, a copy of the certification, registered capital, occupational insurances; the detailed general information includes photographic data of the residence (actual site of business operation), members (partners in a partnership organization, shareholders in a limited company), regulations, the education backgrounds and resumes of members of the decision-making body and professionals, and historical achievements; and the performance capacity information includes but not limit to annual financial reports within 3 years, financial reports of the last month, and occupational obligations and insurance situation.

As to the class A member as an individual, the basic general information includes name, sex, age, where he/she works, pictures (a head picture and a full-length picture in contrast to a reference object at a standard height), a piece of voice recordation about a part of basic self-introduced information, contact address, telephone, certification code; the detailed general information includes identification card, other mainly biological features, education backgrounds, resume, situation of the main relatives of a family; and the performance capacity information includes but not limit to in-home personal debt situation and occupational insurance situation.

Concerning the class A member's negative information, it is a need for the unit to not exist the circumstances of a bad credit record or insolvency, and it is a need for the individual to have neither a property criminal record in history nor fatefully bad debts, addiction of drug and gamble, or poor credit record at present.

Founders of opening the online market are selected from lawyers to verify the general information and performance capacity information of the professional institution and person, and confirm conditions of conforming the class A member, and then approve to be the class A member.

The online market founder or the lawyer as the class A member verifies the general information and performance capacity information of the key personnel to be in charge of the online market administrative organization. The persons after being verified are inaugurated in the online market and become the class A member.

The lawyer as the class A member verifies the general information and the performance capacity information of the lawyers who are willing to be the class A member, so that the law offices and lawyers who conform to the conditions will become the class A member.

The lawyer as the class A member verifies the general information and the performance capacity information of the other intermediary agencies and the employees thereof who are willing to be the class A member, so that the enterprises and individuals who conform to the conditions will become the class A member.

The lawyers in a career of verification testify the general information and performance capacity information, and submit the information to the market administrative institution by converting the information into data files to be stored on the magnetic media unit or the optical recording media, or via the Internet by using the terminal unit. The administrative institution inputs the class A member's general information and performance capacity information into the market website server, wherein the basic general information can be self-browsed by the members, and the administrative permission of browsing the other general information and performance capacity information is consigned to the class A member themselves such that the class A member's other general information and performance capacity information will be browsed or downloaded by other members as long as they are authorized thereby.

Submitting and recording the general information and performance capacity information of the class B member,

As to the class B member as a unit:

the basic general information includes name, legal representatives or a person in charge, address, business license, institution code (if have), tax registration certification (if have), registered capital, actual site of business operation and means of communication and contact way;

the detailed general information includes but not limit to definite location of the residence and/or site of business operation, outer appearance of the house, interior photographic data, industry admittance certification if there is limitation under the industry admittance conditions, members (partners in a partnership institution, shareholders in a limited company, and substantial shareholders in a limited liability company), regulations, members of decision-making body, employed business representatives having the basic general information such as name, sex, age, pictures (a head picture and a full-length picture in contrast to a reference object at a standard height), a voice recordation of a part of basic self-introduced information, contact way, identification card, other mainly biological features, education backgrounds, resume, situation of the main relatives of a family, and personal debt situation; and

the performance capacity information includes but not limit to annual financial reports of the first three years, the financial reports of last month, technology, production facilities, constitution of technicians, producing and technical cooperation units, performance bond situation, insurance situation if the product quality insurance and the product liability insurance are contained and so on.

As to the class B member as an individual:

the basic general information includes: trade name, residence, business license, site of business operation, the outer appearance of the house, tax registration certification and means of communication and contact way;

the detailed general information includes but not limit to industry admittance certification if there is limitation under the industry admittance conditions; the business owner's name, sex, age, pictures (a head picture and a full-length picture in contrast to a reference object at a standard height), a voice recordation of a part of the basic self-introduced information, identification card, other mainly biological features, education backgrounds, resume, situation of the main relatives of a family, and personal debt situation, and the basic information and the detailed information of the employed business representatives with reference to those of the above-mentioned business representatives of a unit; and

the performance capacity information includes but not limit to individual properties and debts: annual financial reports of the first three years (if have) and the annual financial reports of recent months (if have); technology, production facilities, constitution of technicians, producing and technical cooperation units, performance bond situation, insurance situation if the product quality insurance and the product liability insurance are contained etc.

The class B member submits their own general information and performance capacity information to the market administrative institution by converting the information into data files to be stored in the magnetic media unit or the optical recording media, or via the Internet by using the terminal unit; and the online market administrative institution inputs the information into the market website server, wherein the basic general information can be self-browsed by the class B member, and the administrative permission of browsing the other general conditional information and performance capacity information is consigned to the class B member, so that the class B member's other general conditional information and performance capacity information can be browsed or downloaded by the other members as long as they are authorized thereby.

The class B member entrusts the lawyer of the class A member to verify the general information and performance capacity information partially or completely and mark the verified information; and then, the lawyer of the class A member submits the information to the market administrative institution by converting the information into the data files to be stored in the magnetic media unit or in the optical recording media; the administrative institution inputs the information into the market website server or the lawyer of the class A member inputs the information by using the terminal unit over the Internet; wherein the basic general information can be self-browsed by the members, and the administrative permission of browsing the other general information and performance capacity information is consigned to the class A member so that the other general information and performance capacity information can be browsed or downloaded by the other members as long as they are authorized thereby.

Submitting and recording the general information and the performance capacity information of the class C member;

As to the class C member as an individual:

The basic general information includes name, sex, age, identification card, and contact way;

The detailed general information includes but not limit to pictures (a head picture and a full-length picture in contrast to a reference object at a standard height), a voice recordation of a part of the basic self-introduced information, other mainly biological features, education background, resume, situation of the main relatives of a family, and personal debt situation;

As to the class C member as a unit:

the basic general information includes name, sex, age, identification card, contact way and the contact's name; and

the detailed general information includes but not limit to definite location of the residence and/or site of business operation, outer appearance of the house, a person in charge of a company, members of decision-making body, the representatives' name, sex, age, identification card, pictures (a head picture and a full-length picture in contrast to a reference object at a standard height), a voice recordation of a part of basic self-introduced information, contact way, other mainly biological features, education backgrounds, resume, situation of the main relatives of a family, and personal debt situation.

Generally, the class C member merely declares the basic general information. The class C member or his/her representative inputs the information into the market website server via the Internet by using the terminal unit.

If the class C member intends to conduct a single large-amount transaction or an installment payment transaction, the class C member may, as desired, request the lawyers of the class A member to verify the general information and the performance capacity information and to mark the verified information; after verification, the lawyers of the class A member submits the information to the market administrative institution by converting the information into data files to be stored in the magnetic media unit or the optical recording media, or via the Internet by using the terminal unit; the administrative institution inputs the class B member's general information and performance capacity information into the market website server; or the lawyers of the class A member directly inputs the information to the market website server via the Internet by using the terminal unit; wherein the basic general information can be self-browsed by the class C member, and the administrative permission of browsing the other general conditional information and performance capacity information is consigned to the class C member so that the class C member's other general information and performance capacity information can be browsed or downloaded by the other members as long as they are authorized thereby.

Under a principle of direct trial, the above information verification must be personally operated or treated through on-scene supervision by the checker. An electronic signature secure key and password must be given face to face, and are signed for by the checker himself/herself or signed for by the proprietor along with the representative.

No matter whether the members' information has been verified by the class A member, the online market can entrust the other class A members to make a verification or make a self-verification to the members' information according to previously approved market rules. If the fake information is confirmed, the proprietor shall bear the corresponding liability according to the market rules; and moreover, if the fake information has been verified by the class A member, the class A member in charge of verifying work should not only independently bear the liability for breach of contract but also bear the joint liability for the members who made fault.

At the market website, according to classification of goods and service presented in order of the classes of the Nice Classification, the members' information are displayed in terms of specific goods and service bought or sold by the members; and search criteria is defined on the basis of a continent, a county (district), a first administrative region, a second administrative region, a third administrative region, buyers or sellers, and producers or merchants.

The class B member and the class C member visit the online market website server via the Internet by using individual terminal unit to acquaint both sides with the general information and performance capacity information from one another, and then negotiate transactions and sign a contract by writing and/or speech over the Internet on the basis of actual realization of the performance capacity of both sides.

The class B member as a seller provides goods or service. The class B member or the class C member as a buyer makes online payment to close the transaction.

In the case of altering the members' general information and the performance capacity information, with reference to the above procedures, the information at the market website server need to be updated timely.

With respect to the members' information, the market administrative institution always initially entrusts the class A member to verify or self-verify the information according to rules or depending on the members' denouncement. After it is ascertained that the members' information is fake, the proprietor shall bear the corresponding liability for breach of the contract according to the rules in order to ensure accuracy and credibility of the members' information at the online market website as well as security and facilitation of online transactions. If the members are unable to comply with the market rules to bear liability or carry the contract, and further fail to bear the liability for breach of the contract or pay the compensation according to the contract, the members will be disqualified and thereby do not continue the transactions at the online market.

In the case of occurrence of any dispute among the members, conciliation will be conducted by the market administrative institution according to the market rules, or arbitration that is executed according to the arbitration rules of the online market will be requested by the members according to the market rules, as a result of this, the dispute will be settled.

In the market, a professional ethics consultative committee is set up for dealing with lawsuits relating to the class A member and the junior employees of the market administrative institution. The professional ethics consultative committee is set up for dealing with complaints regarding the professional ethics. In the light of the circumstances, the market will strive for an achievement that arbitrators will be restricted according to the professional ethics and accept the judgment made by the professional ethics consultative committee.

Since the class A member insures an occupational insurance, economic responsibility, which should be taken on when the class A member makes faults during performing the duty, will be compensated by the insurance company in the range of risks covered by the occupational insurance.

By means of inter-supervision between the class A members, between the class B members, and between the class A member and the class B member, and receiving supervision of the class C member, the members can be rewarded and can be given an ample reward in the food industry relating to security and health of human beings if any active supervision is made.

### 2. Embodiments with Limitations

a. If the Wal-Mart, as the class B member carrying out the present invention at the online market, intends to choose a new manufactory X as a supplier.

The Wal-Mart had entrusted a business credit investigation company to conduct creditworthy investigation of X, but now the Wal-Mart is informed that X is of a class B member at the online market, and its general information and performance capacity information have been verified by the lawyers of the class A member.

So that the Wal-Mart can request the lawyers of the class A member to verify X according to a factory inspection required by the Wal-Mart.

After verification, Y makes a confirmation that X conforms to the factory inspection required by the Wal-Mart, issues certifying documents, and inputs such information into the market website server via the Internet by using the individual terminal unit.

The Wal-Mart may acquire authorization from X to look up and download the certifying documents of X according with the factory inspection required by the Wal-Mart issued by Y at the online market website server.

Therefore, the Wal-Mart can establish a buying and selling goods relationship with X.

b. Provided that an employee X of an American wholesale company was fired, X has business experiences and marketing channels without money running business, however, he received a legacy of a large house in value of $2 million.

X intends to do business with a Chinese export enterprise previously acquainted under a condition that the payment will be made until the goods has been reached for three months.

X opens a company and becomes the class B member at the online market. X mortgages the house for security of payment at maximum amount of $1.2 million, and invites a lawyer of the member A at the American online market to verify and testify factuality and validity of mortgage guarantee.

Y is of the class B member at the online market as well, so that X and Y, under restriction of the online market rules, conduct their business that payment will be made until the goods have been reached for three months within the amount of $1.2 million without any worry.

In the case of occurring any dispute, for instance, if X does not fulfill the payment within due time, Y can file a request of intermediation and arbitration according to rules of intermediation and arbitration of the online market.

An intermediation and arbitration institution (a judge) hears a case according to the rules of intermediation and arbitration of the online market, and suggest intermediation or make an arbitration adjudication according to the contract signed by X and Y and the online market rules so as to settle the dispute.

Herein, rules in a prosecution procedure and rules for rights and obligations of an entity are provided in unification by the online market, in this case, Chinese and American which have two completely different social systems do business according to the unified rules and settle the disputes according to the unified rules over the Internet.

In terms of industrial applicability, by using a method of conducting transactions over the Internet of the present invention, both sides enable to learn about the general information and the performance capacity information from one another in time via the online market website server when conducting online transactions. Furthermore, such an extent acknowledged exceeds understanding of a traditional face-to-face transaction. A virtual online transaction becomes a real online transaction. The transaction abides by the preset whole set of rule system. If any dispute is occurred, intermediation or arbitration of the dispute is made according to a unified set of rules, and thereby to settle the dispute. In this case, security and facility of online transactions have a great improvement.

1. A method of conducting transactions over the Internet, comprising following components and steps:
1) opening an online market, carrying out membership, members being classified into:
Class B member that is a proprietor participating in the online goods and service transactions for a commercial purpose and has a network terminal apparatus; and
Class C member that is a purchaser participating in the network goods and service transaction for a purpose of compensation and has a network terminal apparatus;
2) establishing a market website, and equipping with a market website server;
3) drafting a whole set of market rules and system which mainly includes members' information recordation, submitting rules, rules of mutually referring information, standard contract and transaction rules, rules of liability for breach of contract, and rules of dispute settlement;
4) wherein the class B member previously confirms acceptance of the online market rules, and according to the rules, faithfully submits individual general information and performance capacity information to a market administrative institution by converting the information as data files to be stored on a magnetic media unit or an optical recording media, or via the Internet by using an individual network terminal unit; the market administrative institution inputs the information into the market website server in a manner that the market administrative institution verifies the information partially or completely depending to the class B member or directly records a part of information; and the market administrative institution marks the verified information and inputs all the unverified and verified information into the market website server;
5) wherein the class C member previously confirms acceptance of the online market rules, and according to the rules, faithfully submits individual general information and performance capacity information to a market administrative institution by converting the information as data files to be stored on the magnetic media unit or the optical recording media, or via the Internet by using the individual network terminal unit; the market administrative institution inputs the information into the market website server; or the market administrative institution verifies the information partially or completely depending on the class C member, or directly records a part of information; and the market administrative institution marks the verified information and inputs all the unverified or verified information into the market website server;
6) wherein the market administrative institution sets a part of basic general information to be browsed online per capita, and hands administrative privilege of password of the information that is not desired to be browsed online per capita by the members and performance information to the class B member and the class C member themselves such that the members can manage their information consulted objects in a manner of setting, altering and handing the password;
7) wherein the class B member and the class C member, using their individual network terminal unit, visit the market website server via the network to learn about the basic general information from one another, let the counterpart to know the password at one's own will, and authorize the counterpart to acknowledge partial or complete general information and performance capacity information stored at the market website server via the Internet;
8) wherein between class B members and between the class B member and the class C member, they negotiate transactions and then sign a contract by writing and/or speech over the network on the basis of really having acknowledged the information from one another; and
9) wherein the class B member as a seller provides goods or services; and the class B or C members as a buyer fulfills payment to close the transaction via the network by using the individual network terminal unit.

2. The method of conducting transactions over the Internet according to claim 1, characterized in that the member shall bear liability for breach of the contract if he/she submits fake information, or the submitted goods and services are not in conformity with a contract agreement or a quality standard.

3. The method of conducting transactions over the Internet according to claim 1, characterized in that the market administrative institution can initiatively check the information or goods and service submitted by the class B member according to the market rules, for instance, the class B member shall bear for breach of the contract if he/she submits the fake information or the goods and services as submitted are not in conformity with the standard.

4. The method of conducting transactions over the Internet according to claim 1, characterized in that in the case of occurrence of any dispute between the members, intermediation or arbitration is conducted so as to settle the dispute, according to the online market rules.

5. The method of conducting transactions over the Internet according to claim 1, characterized in that:
10) in the market, there is class A member that is a professional institution or person providing security service for market transaction order and has a network terminal apparatus;
11) the class A member previously confirms acceptance of online market rules, and submits individual general information and performance capacity information to be verified by an online market administrative institution or the other class A members; or a checker directly records the partial or complete information, and submits the information to the market administrative institution by converting the information as data files to be stored on a magnetic media unit or an optical recording media, or sends the information to the market administrative institution over the Interne; and the administrative institution inputs the information into the market website server;
12) the class A member can verify the partial or complete general information and performance capacity information, or directly record the information, and submit verified result or directly recorded information to the market administrative institution, and input the information into the market online server, as requested by the class B and C members or entrusted by the online market administrative institution;
13) the class A member can be entrusted by the market administrative institution to verify whether the class B member has an action of breaking the market rules, and then a decision is made by the market administrative institution; or after verification, when the market administrative institution deems that the class B member' action does not breaking the market rules or does not make a decision in time, an arbitration adjudication can be requested directly;
14) the class A member shall bear for breach of the contract and/or bear joint liability associated with the class B member's breach of contract if the class A member offends his/her duty.

6. The method of conducting transactions over the Internet according to claim 5, characterized in that the market administrative institution drafts professional ethics of the junior employees of the market administrative institution and the class A member; and a professional ethic consultative institution is established in the market to deal with lawsuit about the professional ethics.

7. The method of conducting transactions over the Internet according to claim 1, characterized in that the market administrative institution copies the members' information in papers, the magnetic media unit or the optical recording media; and the market administrative institution can provide the member' information testified by the market administrative institution according to the member's instructions.

8. The method of conducting transactions over the Internet according to claim 1, characterized in that by means of inter-supervision between the class A members, between the class B members, and between the class A member and the class B member, and receiving supervision of the class C member, the members can be rewarded and can be given an ample reward in the food industry relating to security and health of human beings if any active supervision is made.

9. The method of conducting transactions over the Internet according to claim 2, characterized in that the market administrative institution copies the members' information in papers, the magnetic media unit or the optical recording media; and the market administrative institution can provide the member' information testified by the market administrative institution according to the member's instructions.

10. The method of conducting transactions over the Internet according to claim 3, characterized in that the market administrative institution copies the members' information in papers, the magnetic media unit or the optical recording media; and the market administrative institution can provide the member' information testified by the market administrative institution according to the member's instructions.

11. The method of conducting transactions over the Internet according to claim 4, characterized in that the market administrative institution copies the members' information in papers, the magnetic media unit or the optical recording media; and the market administrative institution can provide the member' information testified by the market administrative institution according to the member's instructions.

12. The method of conducting transactions over the Internet according to claim 5, characterized in that the market administrative institution copies the members' information in papers, the magnetic media unit or the optical recording media; and the market administrative institution can provide the member' information testified by the market administrative institution according to the member's instructions.

13. The method of conducting transactions over the Internet according to claim 2, characterized in that by means of inter-supervision between the class A members, between the class B members, and between the class A member and the class B member, and receiving supervision of the class C member, the members can be rewarded and can be given an ample reward in the food industry relating to security and health of human beings if any active supervision is made.

14. The method of conducting transactions over the Internet according to claim 3, characterized in that by means of inter-supervision between the class A members, between the class B members, and between the class A member and the class B member, and receiving supervision of the class C member, the members can be rewarded and can be given an ample reward in the food industry relating to security and health of human beings if any active supervision is made.

15. The method of conducting transactions over the Internet according to claim 4, characterized in that by means of inter-supervision between the class A members, between the class B members, and between the class A member and the class B member, and receiving supervision of the class C member, the members can be rewarded and can be given an ample reward in the food industry relating to security and health of human beings if any active supervision is made.

16. The method of conducting transactions over the Internet according to claim 5, characterized in that by means of inter-supervision between the class A members, between the class B members, and between the class A member and the class B member, and receiving supervision of the class C member, the members can be rewarded and can be given an ample reward in the food industry relating to security and health of human beings if any active supervision is made.
